(19) United States
(12) Patent Application Publication
(10) Pub. No.: US 2009/0200402 A1
(43) Pub. Date: Aug. 13, 2009

(54) Fuel injector

(76) Inventors: Markus Gesk, Karlsbad (DE); Guenter Dantes, Eberdingen (DE); Joerg Heyse, Besigheim (DE); Andreas Krause, Unterriexingen (DE)

Correspondence Address: KENYON & KENYON LLP, ONE BROADWAY, NEW YORK, NY, 10004, US

(21) Appl. No.: 11/664,858

(22) PCT Filed: Sep. 20, 2005
(86) PCT No.: PCT/EP2005/054698

§ 371 Date: Apr. 6, 2007

(30) Foreign Application Priority Data
Oct. 9, 2004 (DE) 10 2004 049 280.8

(51) Int. Cl. F02M 61/18

(52) U.S. Cl. 239/533.12; 239/533.2

(57) ABSTRACT

The fuel injector including an orifice plate which is provided with a multitude of outlet openings and situated downstream from a valve-seat body having a fixed valve seat. Directly upstream from the outlet openings is an inflow opening having an annular inflow cavity. The valve-seat body covers the inflow cavity in such a way that the downstream outlet openings of the orifice plate are covered. The outlet openings each have an inflow region whose diameter D1 is considerably larger than the diameter D2 of a region that abuts at a sharp angle directly downstream therefrom, which forms the narrowest cross section of the outlet opening and from where the outlet opening widens in the flow direction to a diameter D3 in a trumpet-shaped manner. The fuel injector may be particularly suitable for use in fuel injection systems of mixture-compressing ignition engines having externally supplied ignition.

### FIELD OF THE INVENTION

The present invention relates to a fuel injector.

### BACKGROUND INFORMATION

A fuel injector with an orifice plate having a plurality of outlet openings downstream from a fixed valve seat is described in German Patent No. DE 42 21 185. Using stamping, the orifice plate is first provided with at least one outlet opening, which extends parallel to the longitudinal valve axis. The orifice plate is then plastically deformed in its mid section where the outlet openings are located, by deep-drawing, so that the outlet openings extend at an incline relative to the longitudinal valve axis and widen frustoconically or conically in the flow direction. In this manner, excellent conditioning and good jet stability of the medium discharged through the outlet openings are achieved compared to conventional fuel injectors; however, the manufacturing process of the orifice plate with its outlet openings is very complex. The outlet openings are provided directly downstream from an outlet orifice in the valve-seat body and are therefore directly exposed to the flow.

Japanese Published Application No. JP 2001-046919 describes a fuel injector in which an orifice plate having a plurality of outlet orifices is provided downstream from the valve seat. An inflow opening, which has a larger diameter and forms an annular inflow cavity for the outlet opening, is formed between an exit opening in the valve-seat body and the orifice plate. The outlet openings of the orifice plate are in direct flow connection with the inflow orifice and the annular inflow cavity and covered by the upper boundary of the inflow orifice. In other words, there is a complete offset from the exit opening determining the intake of the inflow opening and the outlet openings. The radial offset of the outlet openings relative to the exit opening in the valve-seat body causes an s-shaped flow characteristic of the fuel, which constitutes an atomization-promoting measure. The inflow opening, which determines the s-shaped characteristic of the flow, has a constant height throughout.

German Application No. DE 196 07 277 describes a fuel injector with an orifice plate having a plurality of functional planes with different opening geometries. The individual functional planes of the orifice plate are set up on top of one another using galvanic metal deposition (multi-layer electroplating). In this fuel injector, the valve-seat body must under no circumstances restrict or cover the intake openings in the upper functional level of the orifice plate.

### SUMMARY

A fuel injector according to an example embodiment of the present invention, may have the advantage of achieving a uniform and very fine atomization of the fuel in a simple manner, and of obtaining an especially high conditioning and atomization quality with very tiny fuel droplets. In an advantageous manner, this is achieved by providing an orifice plate as atomizer disk downstream from a valve seat, whose outlet openings have a specific geometry. Using the orifice plate according to the example embodiment of the present invention, it may be possible to spray-discharge fuel sprays with an atomization quality of approx. 20 μm of the SMD, the so-called Sauter mean diameter of the fuel droplets as a measure of the atomization quality.

The horizontal velocity components of the flow discharging into the outlet openings are not impeded by the walls of the respective outlet opening at the entry plane, so that the fuel jet has the full intensity of the horizontal components generated in the inflow cavity when leaving the outlet opening, and therefore fans out at maximum atomization.

In an advantageous manner, an inflow opening having the annular inflow cavity may be provided in the valve-seat body upstream from the outlet openings, the inflow opening being larger than an exit opening downstream from the valve seat. The valve-seat body thus already assumes the function of a flow controller in the orifice plate. In an especially advantageous manner, due to the form of the inflow opening, an s-deflection may be achieved in the flow for better atomization of the fuel since the valve-seat body covers the outlet openings of the orifice plate by the upper boundary of the inflow opening.

Using galvanic metal deposition, it may be advantageously possible to produce the orifice plates simultaneously, in large lot numbers and in reproducible, extremely precise as well as inexpensive fashion. Moreover, this manufacturing method allows extremely great freedom in design since the contours of the openings in the orifice plate are freely selectable.

### BRIEF DESCRIPTION OF THE DRAWINGS

Exemplary embodiments of the present invention are shown in simplified fashion in the figures and are explained in greater detail below.

FIG. 1 shows a partially illustrated fuel injector.

FIG. 2 shows an enlarged view of the cut-away portion II in FIG. 1, with an inflow cavity in the valve-seat body and an orifice plate having a multitude of outlet openings.

FIG. 3 shows a first exemplary embodiment of an outlet opening formed according to the present invention.

FIG. 4 shows a second exemplary embodiment of an outlet opening formed according to the present invention.

FIGS. 5A through 5C show three production steps in the manufacture of an orifice plate according to an example embodiment of the present invention, in the region of an outlet opening.

### DETAILED DESCRIPTION OF EXAMPLE EMBODIMENTS

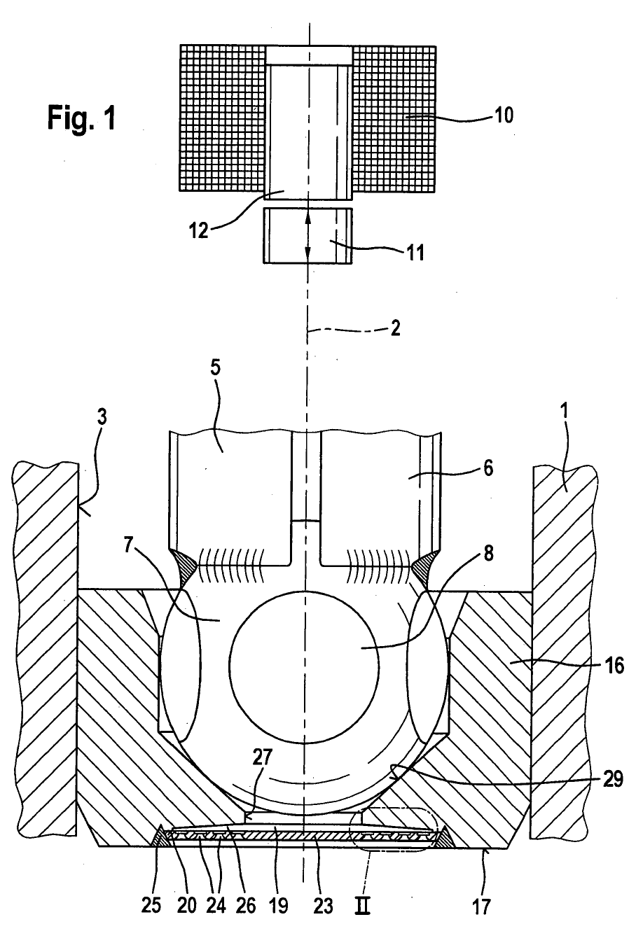

FIG. 1 shows as an exemplary embodiment a partial view of a valve in the form of a fuel injector for fuel injection systems of mixture-compressing, externally ignited internal combustion engines. The fuel injector has an only schematically sketched tubular valve-seat support 1, which forms part of a valve housing and in which a longitudinal opening 3 is formed concentrically with respect to a longitudinal valve axis 2. Situated in longitudinal opening 3 is a tubular valve needle 5, for instance, whose downstream end 6 is securely joined to, for instance, a spherical valve closure member 7 at whose periphery five flattened regions 8, for example, are provided for the fuel to flow past.

The fuel injector is actuated in a conventional manner, e.g., electromagnetically. A schematically sketched electromagnetic circuit including a magnetic coil 10, an armature 11 and a core 12 is used for axial displacement of valve needle 5, and thus for opening the fuel injector against the spring tension of a restoring spring (not shown), or for closing it. Armature 11 is joined to the end of valve needle 5 facing away from valve-closure member 7 by a welding seam, formed by laser, for instance, and points to core 12.

A valve-seat body 16 is mounted on the downstream end of valve-seat support 1, for instance by welding, so as to form a seal. At its lower front end 17, facing away from valve-closure member 7, valve-seat body 16 has a stepped design, a recess 20 being provided in a center region about longitudinal valve axis 2 in which a flat, one-layered orifice plate 23 is situated. Orifice plate 23 has a multitude of outlet openings 24, ideally, up to four hundred outlet openings 24 due to the small opening widths. Upstream from recess 20, and thus upstream from outlet openings 24 of orifice plate 23, an inflow opening 19 is provided in valve-seat body 16 via which the individual outlet openings 24 are exposed to the flow. Inflow opening 19 has a larger diameter than the opening width of an exit opening 27 in valve-seat body 16 from where the fuel discharges into inflow opening 19 and finally into outlet openings 24.

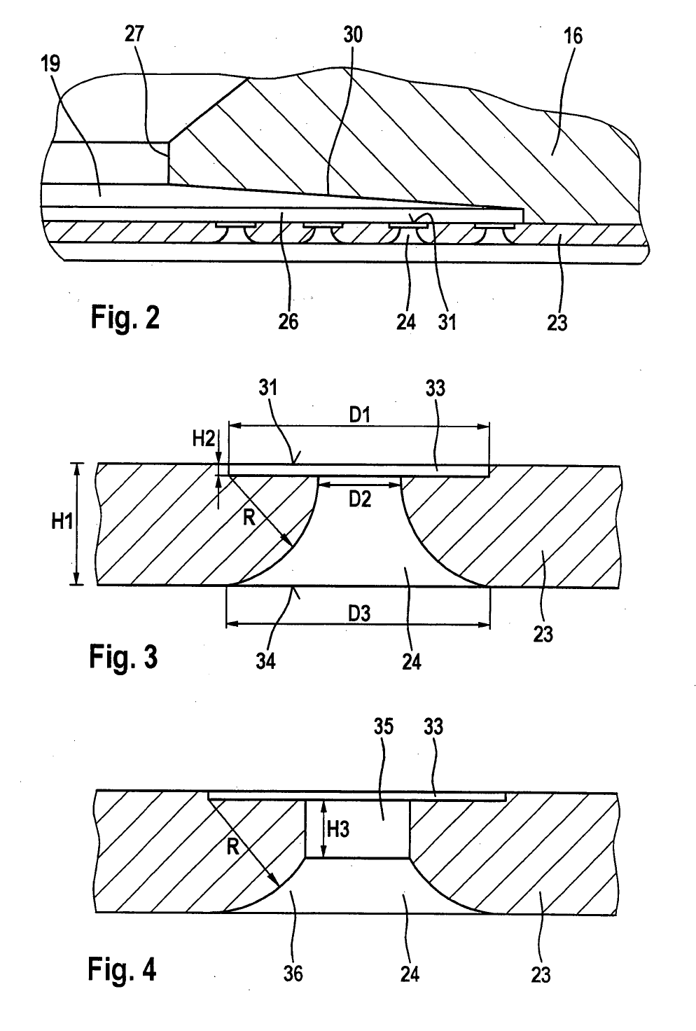

Inflow opening 19 has a specific geometry in the immediate inflow region of outlet openings 24. The annular region of inflow opening 19 having a larger diameter than exit opening 27 is shown in FIG. 2 in an enlarged view and referred to as inflow cavity 26 below.

The connection of valve-seat body 16 and orifice plate 23 is implemented by, for instance, a circumferential and tight welding seam 25, formed by laser, which is located outside of inflow opening 19. Once orifice plate 23 has been fixed in place, it is positioned inside recess 20 in a recessed manner with respect to end face 17.

The insertion depth of valve-seat body 16 having orifice plate 23 in longitudinal opening 3 determines the magnitude of the lift of valve needle 5 since, when magnetic coil 10 is in the non-energized state, one end position of valve needle 5 is defined by the seating of valve-closure member 7 on valve-seat surface 29 of valve-seat body 16, which tapers conically in a downstream direction. When magnetic coil 10 is energized, the other end position of valve needle 5 is defined by the seating of armature 11 on core 12, for instance. The path between these two end positions of valve needle 5 therefore constitutes the lift.

Outlet openings 24 of the orifice plate 23 are in direct flow connection with inflow opening 19 and annular inflow cavity 26 and covered by the upper boundary of inflow opening 19. In other words, there is a complete offset from exit opening 27, which defines the intake of inflow opening 19, and outlet openings 24. The radial offset of outlet openings 24 relative to exit opening 27 brings about an s-shaped flow pattern of the medium, i.e., the fuel in this case.

In this embodiment, the so-called s-twist in front of and within orifice plate 23, with several pronounced flow deflections, imparts a strong, atomization-promoting turbulence to the flow. The velocity gradient transversely to the flow is thereby particularly pronounced. It is an expression for the change in the velocity transversely to the flow, the velocity being markedly greater in the center of the flow than in the vicinity of the walls. The higher shear stresses in the fluid resulting from the velocity differences promote the disintegration into fine droplets in the vicinity of outlet openings 24. According to embodiments of the present invention, the specific geometry of outlet openings 24 has an additional, positive effect on the atomization of the fluid, so that an even better disintegration into the finest droplets is realizable.

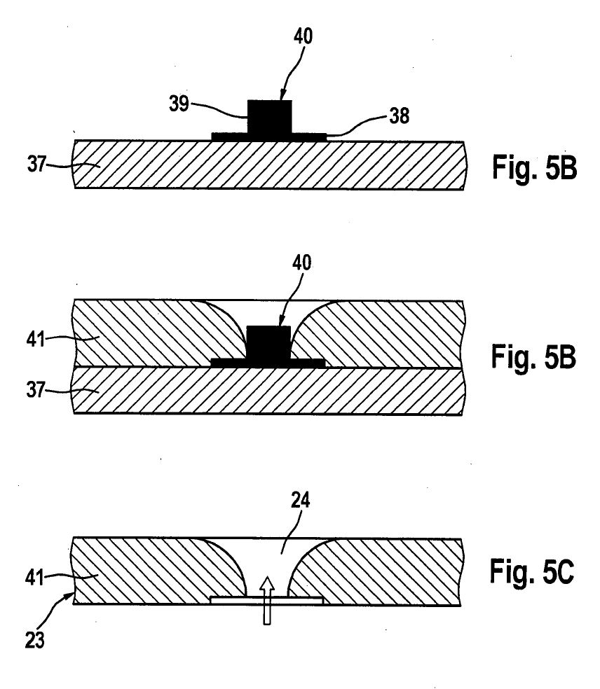

Orifice plate 23 is produced by galvanic metal deposition; producing one-layer orifice plate 23 by so-called lateral overgrowth technology, in particular, is advantageous, which will be elucidated in greater detail on the basis of FIGS. 5A to 5C.

FIG. 2 shows an enlarged cut-away portion II in FIG. 1 to illustrate the geometry of inflow cavity 26 between a boundary surface 30 of valve-seat body 16 and orifice plate 23, as well as the geometry of outlet openings 24 in orifice plate 23. Valve-seat body 16 is designed in such a way, for instance, that boundary surface 30 becomes progressively more inclined in a radially outward direction, beginning at exit opening 27 in the direction of orifice plate 23. This has the result that the height of inflow cavity 26 steadily decreases above entry planes 31 of outlet openings 24 extending perpendicular to longitudinal valve axis 2 (drop in height of inflow cavity 26 from 100 μm to 30 μm, for instance), and the flow is steadily accelerated on the way to radially outer outlet openings 24. The up to four hundred outlet openings 24 are situated, for instance, on a plurality of concentric circular paths in orifice plate 23. The clearances between individual outlet openings 24 amount to approximately 120 to 150 μm, for example.

Outlet openings 24 ideally have a trumpet-shaped contour, an upstream inflow region 33 having a cylindrical cross section. Inflow region 33 has a considerably greater diameter than an immediately adjacent opening region of actual trumpet-shaped outlet opening 24. FIGS. 3 and 4 illustrate two exemplary embodiments of outlet openings 24 formed according to the present invention.

To explain the absolute size and the size ratios of the individual sections of outlet opening 24, a few dimensions of outlet openings 24 shall be provided in the following by way of example, using FIG. 3. Thickness H1 of overall orifice plate 23 amounts to approximately 50 to 100 μm. However, inflow region 33 of outlet opening 24 has a height H2 of only approx. 3 to 5 μm. Diameter D1 of inflow region 33 of outlet opening 24 is on the order of magnitude of approx. 100 to 150 μm, for instance, and thus greater than thickness H1 of orifice plate 23. That is to say, after approx. 3 to 5 μm of axial length of outlet opening 24, this diameter-sized inflow region 33 is followed downstream, at a sharp angle, by a section whose diameter is considerably smaller and has a diameter D2 of only approximately 30 to 100μ. D2 consequently is the narrowest diameter of entire outlet opening 24. Starting at this diameter D2, outlet opening 24 widens in a continuous arc, for instance, in particular in the form of a trumpet having a constant radius R of the convexity of the wall in the downstream direction. In this manner, a diameter D3, which largely corresponds to diameter D1 of entry plane 31 and thus inflow region 33, is achieved at exit plane 34 of outlet opening 24, so that it also amounts to approximately 100 to 150 μm.

The exemplary embodiment shown in FIG. 4 differs from outlet opening 24 shown in FIG. 3 mainly in that the trumpet-shaped opening region is subdivided into two sections; a first upstream section 35 has a largely cylindrical contour, while a second downstream section 36 has a funnel-shaped contour. Given a thickness H1 of orifice plate 23 of approximately 50 to 100 μm, first cylindrical section 35 has a length H3 of approximately 20 to 50 μm. Radii R of the convexities of the walls of outlet openings 24 of both exemplary embodiments are ideally constant and have their center point precisely in the lower limiting angle of inflow regions 33.

The production steps of the manufacture of orifice plate 23 according to the present invention are elucidated with the aid of FIGS. 5A through 5C, in particular in the region of an outlet opening 24. Two photo-resist layers 38, 39 are deposited onto a substrate body 37 on top of one another. Second photo-resist layer 39 is deposited only after first photo-resist layer 38 has been masked, exposed and patterned. After masking, exposing and patterning of second photo-resist layer 39, both photo-resist layers 38, 39 are developed in one step, i.e., unexposed portions of photo-resist layers 38, 39 are removed using a wet chemical treatment. In the exposed areas, stepped photo-resist towers 40 remain standing on substrate body 37 as remains of photo-resist layers 38, 39, that is to say, precisely at the locations where outlet openings 24 in orifice plate 23 are to be created. In first photo-resist layer 38, photo-resist tower 40 has a considerably larger diameter than in second photo-resist layer 39, which, however, has been deposited at a clearly greater height.

In a next process step (FIG. 5b), using a one-step process, metal is galvanized onto substrate body 37 around photo-resist towers 40. Galvanic layer 41 first grows from substrate body 37 in an upward direction, along first photo-resist layer 38, and overgrows the surface of this first photo-resist layer 38 until galvanic layer 41 completely contacts the circumference of second photo-resist layer 39. The electro-deposition is stopped as soon as a slight galvanic layer thickness is present at the circumference of second photo-resist layer 39. Due to the overgrowing of first photo-resist layer 38, a desired funnel-shaped or trumpet-like indentation results in galvanic layer 41 around second photo-resist layer 39 in the region of each photo-resist tower 40 (“lateral overgrowth”). This indentation at each photo-resist tower 40 ultimately forms the strongly diverging part of the individual outlet opening 24 in orifice plate 23.

After removal of photo-resist towers 40 (stripping) and substrate body 37, a one-layer orifice plate 23 having a multitude of outlet openings 24 has been produced (FIG. 5C). As indicated by the arrow in FIG. 5C, in the installed state the flow in outlet openings 24 of orifice plate 23 goes in the direction of the electro-deposition growth. Cylindrical section 35 of outlet opening 24, shown in FIG. 4, having the narrowest cross section, is produced with high precision by electroforming of second photo-resist layer 39.

1-13. (canceled)

14. A fuel injector for a fuel-injection system of an internal combustion engine, having a longitudinal valve axis, the fuel injector comprising:
a valve-seat body having a fixed valve seat;
a valve-closure member, which cooperates with the valve seat and is axially displaceable along the longitudinal valve axis; and
an orifice plate which has a multitude of outlet openings and is situated downstream from the valve seat;
wherein the outlet openings have an inflow region having a first diameter that is substantially larger than a diameter of a region abutting at a sharp angle directly downstream therefrom, which forms a narrowest cross section of the outlet openings and from where the outlet openings widen in the flow direction to a second diameter.

15. The fuel injector as recited in claim 14, wherein the orifice plate has a thickness of approximately 50 to 100 μm.

16. The fuel injector as recited in claim 14, wherein the inflow region has a height of approximately 3 to 5 μm.

17. The fuel injector as recited in claim 14, wherein the inflow region has a diameter of approximately 100 to 150 μm.

18. The fuel injector as recited in claim 17, wherein the outlet openings have a smallest diameter in a sharp-angled transition from the inflow region, the diameter being approximately 30 to 100 μm.

19. The fuel injector as recited in claim 14, wherein the second diameter of the outlet openings widen up to approximately 100 to 150 μm.

20. The fuel injector as recited in claim 14, wherein, beginning with the sharp-angled transition of the inflow region, the outlet opening has one of a trumpet-shaped or a funnel-shaped contour.

21. The fuel injector as recited in claim 20, wherein a wall of the outlet opening has a curvature of constant radius.

22. The fuel injector as recited in claim 21, wherein the radius of the curvature of the wall has a center point in a lower limiting angle of the inflow region.

23. The fuel injector as recited in claim 14, wherein an opening region adjoining the inflow region is subdivided into two sections, a first upstream section having a cylindrical contour, and a second downstream section having a funnel-shaped contour.

24. The fuel injector as recited in claim 14, wherein the orifice plate has up to four hundred outlet openings.

25. The fuel injector as recited in claim 14, wherein an inflow cavity formed upstream from the orifice plate has a sloped design.

26. The fuel injector as recited in claim 14, wherein the orifice plate is produced in one layer by galvanic metal deposition.
